(19) United States
(12) Patent Application Publication
(10) Pub. No.: US 2019/0241132 A1
(43) Pub. Date: Aug. 8, 2019

(54) THERMALLY INSULATING DEVICE

(71) Applicant: FORD GLOBAL TECHNOLOGIES, LLC, Dearborn, MI (US)

(72) Inventors: Andreas Bock, Langenfeld (DE); Robert Wagschal, Ruppichteroth (DE); Thomas Keller, Kreuztal (DE); Phani Vamsi Krishna Anantharaju, Köln (DE); Bernd Dienhart, Koeln (DE)

(21) Appl. No.: 16/269,330

(22) Filed: Feb. 6, 2019

(30) Foreign Application Priority Data
Feb. 7, 2018 (DE) 102018201908.8

(51) Int. Cl. B60R 13/08

(52) U.S. Cl. CPC B60R 13/0815; B60R 13/0212

(57) ABSTRACT

A thermally insulating device for a vehicle includes at least a first molded component which is constructed at least partially in a planar manner. The first molded device is also shaped in such a manner that it surrounds a hollow space in an air-tight manner. The first molded component has at least a first outer side and at least a first inner side. The first inner side faces the hollow space, and the hollow space is evacuated.

### TECHNICAL FIELD

The document relates to a thermally insulating device for a vehicle, which has a closed hollow space under reduced pressure.

### BACKGROUND

Vehicles consume energy in order to provide a temperature which is pleasant for passengers in the inner vehicle space. Vehicles absorb thermal energy by means of direct or indirect solar radiation or heat radiation from engines and/or exhaust systems. Undesirable heat storage and consequently temperature increase in the inner vehicle space can be counteracted by activating an air-conditioning system which is, however, energy-intensive. Conversely, during winter weather conditions, vehicles transmit thermal energy to the environment. This can be counteracted with a heating of the inner vehicle space, which is also energy-intensive.

An air-conditioning unit is generally provided to cool the temperature in an inner vehicle space within a specific period of time from an (excessively high) temperature which is perceived to be unpleasant down to a comfortable temperature. In order to achieve corresponding desired power levels under all environmental conditions, increasingly efficient air-conditioning systems are provided, with larger compressors in comparison with normal air-conditioning systems (170 cm³ versus 140 cm³), high-power evaporators and condensers, etcetera. However, more efficient air-conditioning systems drive up the vehicles costs, vehicle weight and energy consumption for operating the air-conditioning systems. An object is also to achieve desired power levels with comparatively smaller (conventional) air-conditioning systems.

### SUMMARY

This object is achieved with a thermally insulating device having the features of the main claim. Additional advantageous embodiments and configurations will be appreciated from the subordinate and dependent claims, the Figures and the embodiments. The embodiments can advantageously be combined with each other.

A first aspect relates to a thermally insulating device for a vehicle. That device comprises at least a first molded component which is constructed at least partially in a planar manner and which is shaped in such a manner that it surrounds a hollow space in an air-tight manner. The device has a first outer side and a first inner side. The inner side faces the hollow space. The hollow space of the device is evacuated, that is to say, it has a pressure reduction.

The device advantageously enables shielding of the inner vehicle space against heat radiation, and in particular against solar radiation. In comparison with conventional devices of, for example, foam or polyester nonwoven, heat conduction and heat flow into the vehicle are significantly reduced as a result of the effect of the non-conducting pressure reduction in the device. Advantageously, less powerful air-conditioning systems are thereby required, whereby in economic terms space, weight and costs can be saved.

The term vehicle is intended to be understood to refer to motor vehicles, such as passenger vehicles, trucks, small vans and busses, but also rail-borne vehicles, water-borne vehicles and aircraft.

The term “constructed in a planar manner” means with respect to the molded component that it has significantly higher values in the first and second dimensions (length and width) than in the third (height). That is to say, the molded component comprises a planar material layer. In this instance, the first molded component may be bent along a line in order to form the hollow space and surround it. The device is accordingly also constructed in a planar manner. This is advantageous since it is intended to be arranged on walls of the vehicle without taking up an unfavorably large amount of space.

The term surrounded in an air-tight manner means that the material of the device closes the hollow space in the direction toward the environment and no gas can flow into the pressure reduction. A valve may be arranged in the device in order to enable the pressure reduction by drawing off air or another gas.

In a particularly preferred manner, the first molded component and at least a second molded component (which is constructed at least partially in a planar manner and which has a second outer side and a second inner side) are arranged in such a manner with respect to each other that the inner sides in a state facing each other surround the hollow space. The molded components are connected to each other in an air-tight manner at least at the edges thereof. The dimensions of the device correspond in terms of length and width substantially to those of the first and second molded component. The height of the device is determined by the spacing of the first and second molded components with respect to each other.

There is preferably arranged in the hollow space of the device at least one structural element which supports the structural integrity of the device. In this instance, the structural element advantageously counteracts a potential collapse of the device which could be brought about by the pressure reduction. The structural element acts in this instance in a stabilizing manner.

Preferably, the structural element has at least partially a peak-like protuberance, in which at least two flanks of the structural element taper toward each other. That is to say, the structural element is tapered in an acute manner at one side. In this case, the tip may be constructed in an acute or round manner or flattened. The structural element comprises a material which is suitable for providing the necessary stability.

Preferably, the structural element has a planar construction which is folded in the manner of a harmonica. The structural element comprises in this embodiment not only one peak-like protuberance, but instead a plurality which are arranged beside each other, wherein the tips alternately face the inner side, and wherein the flanks of one peak-like protuberance also constitute the flank of the next peak-like protuberance. Advantageously, the structural element extends in this instance over the entire volume of the hollow space since in this manner the stabilizing effect is provided in a uniform manner for the entire device. It is also possible for the structural element to be constructed in a planar manner, but in this instance to have a different shape from the shape folded in the manner of a harmonica, for example, an undulating form.

In a particularly preferred manner, the structural element has at least one perforation, preferably a plurality of perforations. Consequently, a more effective evacuation of the hollow space is advantageously enabled than without perforations. The perforations are in particular present in the construction of the structural element which is folded in the manner of a harmonica.

Preferably, the material which surrounds the hollow space is connected to each other in addition to the edges at least at one additional location of the hollow space. That is to say, for example, in the embodiment with two molded components, a connection is provided between the first molded component and the second molded component and is located in the center of the hollow space. These additional connections of the material have an advantageous stabilizing effect.

Furthermore, in the edge region of the at least first outer side of the device, there is arranged at least one insulating support. The at least one insulating support is constructed to provide a thermally insulating connection between the device and structures of a vehicle, in which the device is arranged. The insulating support is in this instance arranged in such a manner that it is located at the connection between the device and bodywork components, or at least with components which are directly connected to the bodywork. The said connection may in this instance also be brought about directly by means of the insulating support. In this instance, the insulating support advantageously shields the spaces located between the device and the outer wall of the corresponding vehicle from the inner space of the vehicle. The insulating support has an insulating material, for example, a polymer, for example, a polyester nonwoven, a polystyrene foam or similar advantageous material.

The material of the molded components which form the device may comprise any advantageous material. Preferably, the material of the molded components comprises a polymer material, including in particular a thermoplastic plastics material, in particular polypropylene. In a particularly advantageous manner, a reinforced polymer, in this context also reinforced polypropylene, is used. Polymer materials are advantageously light, stable and suitable for shaping by means of blow molding.

A second aspect relates to a use of the device for arrangement on the inner side of a wall which delimits a vehicle toward the outer side.

A third aspect relates to a vehicle having or incorporating a device as described herein. The advantages of the vehicle correspond in this instance to those of the device.

### BRIEF DESCRIPTION OF THE DRAWING FIGURES

The thermally insulating device is explained in greater detail with reference to the Figures, in which:

FIG. 1 is an illustration of an arrangement of an embodiment of the device.

FIG. 2 is an illustration of an arrangement of the device according to FIG. 1 in a vehicle roof.

FIG. 3 is a cut-out of the illustration according to FIG. 1 at the phantom line circle.

FIG. 4 is an illustration of an embodiment of a structural element which is included in the device according to FIG. 1.

FIG. 5 is an illustration of an arrangement of another embodiment of the device.

FIG. 6 is a schematic view of an arrangement of another embodiment of the device in a vehicle roof.

### DETAILED DESCRIPTION

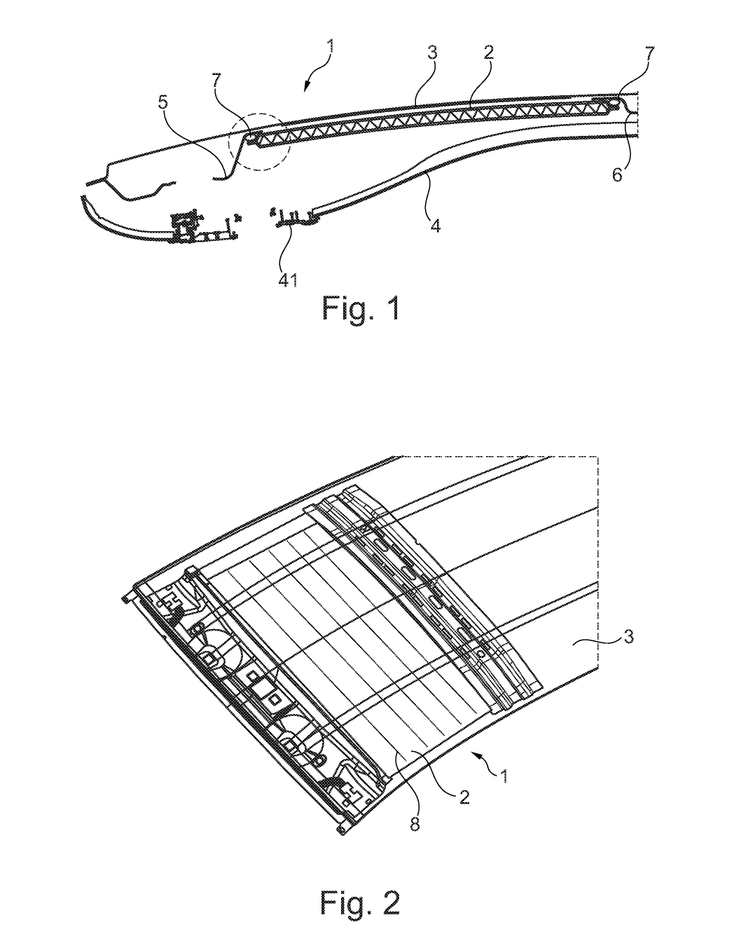

FIG. 1 shows an arrangement 1 of an embodiment of a thermally insulating device 2 under the outer wall 3 of a vehicle roof. The device 2 is arranged between the outer wall 3 and a roof liner 4 (with different fittings 41). The arrangement of the device 2 in a vehicle is in this instance not limited to the roof; lateral walls, for example, in the doors, are also suitable for the device 2. The device 2 is in this instance shown by way of example in a motor vehicle. Furthermore, the device 2 is also suitable for thermal radiation protection for rail vehicles, such as locomotives and wagons, aircraft, such as airplanes and helicopters, and water-borne vehicles, such as boats and ships.

The device 2 is connected in FIG. 1 by means of a front bar 5 and by means of a rear bar 6 to the vehicle bodywork. For stable connection, the device 2 may be connected to additional bars which are not shown. The device 2 may also be directly connected to the outer wall 3.

At the connection locations between the device 2 and the front bar 5 or the rear bar 6, an insulating support 7 is arranged in each case. The insulating support 7 serves to provide a thermally insulating connection between the device 2 and the bodywork. The insulating support has a thermally insulating material, for example, a polymer, for example, a polyester nonwoven, a polystyrene foam or other advantageous material. The connection between the insulating support and the device 2 and the bars 5, 6 can be brought about by means of adhesive bonding, screwing, riveting or other possibilities known to the person skilled in the art. The insulating support 7 is provided as part of the device 2, is thus provided in a state connected to the device 2 for arrangement in a vehicle.

In FIG. 2, a thermally insulating device 2 is illustrated, as arranged in a vehicle roof. In this instance, the device 2 is located below the outer wall 3 of the vehicle roof. The device has a stabilizing inner profile 8.

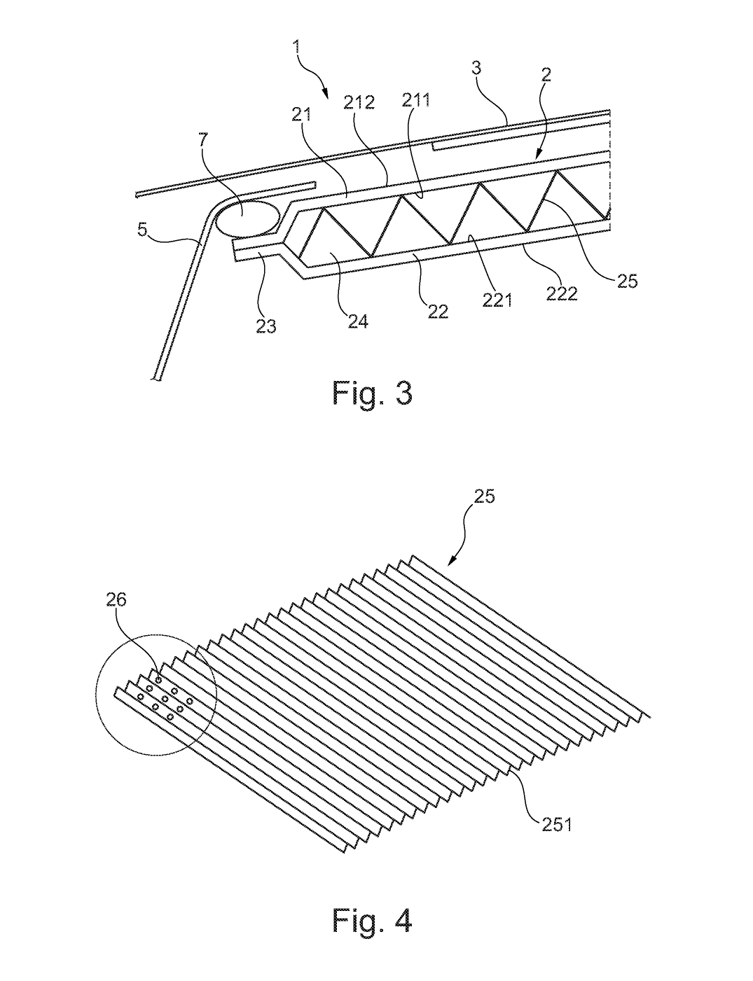

The portion of the arrangement 1 highlighted in FIG. 1 by the circle is illustrated in FIG. 3 as a cut-out. The device 2, the outer wall 3 of a vehicle roof, the front bar 5 and the insulating support 7 are shown as portions of the arrangement. The structure of the device 2 is illustrated here in detail. The device 2 has a first, upper molded component 21 and a second, lower molded component 22. The molded components 21, 22 may be constructed symmetrically and consequently identically. The molded components 21, 22 may, however, also be adapted to the shape of the outer wall of a vehicle, below or beside which wall the device 2 is arranged. In the latter case, they are not constructed identically. The material of the molded components 21, 22 comprises a polymer material, including in particular a thermoplastic plastics material, in particular polypropylene. The polymer material is preferably reinforced, in particular with fibers. It is possible to use as fibers, for example, carbon fibers and/or natural fibers. The material of the molded components may alternatively also comprise a metal, and in this instance also comprise completely a metal or a metal alloy.

The first molded component 21 has a first inner side 211 and a first outer side 212. The second molded component 22 has a second inner side 221 and a second outer side 222.

The molded components 21, 22 are connected to each other by means of a weld connection. For stable connection by means of welding, a weld flange 23 is formed on both molded components 21, 22. The insulating support 7 is arranged at the outer side 212 of the weld flange 23 of the first molded component 21.

A hollow space 24 is formed between the molded components 21, 22 as a result of the shape of the molded components. The hollow space 24 is characterized by a pressure reduction. The pressure reduction may, for example, be produced by means of suction of air from the hollow space 24 through a valve which is not shown.

In order to stabilize the device 2, that is to say, to prevent a collapse of the molded components 21, 22 by the pressure reduction, a structural element 25 is arranged between the molded components 21, 22. The structural element 25 shown in FIGS. 1 and 3 in the device 2 is illustrated in FIG. 4 individually as a three-dimensional view. In the embodiment shown, the structural element 25 is as an overall impression constructed in a planar manner but in this instance folded to have corrugations in the manner of a harmonica. As a result of the bellows or harmonica-like folding, the structural element 25 has adjacent peak-like sub-structures 251 which each comprise two flanks which taper toward each other and which terminate in a tip. The tips are alternately directed toward the first inner side 211 and the second inner side 221. In this instance, the flank of one sub-structure is also the flank of the next. The “tips” may also be constructed in a rounded or flattened manner, wherein mixed shapes, in which, for example, flattened or rounded tips are constructed alternately, are possible.

The material of the structural element 25 is a material which is suitable for constructing a stable arrangement, for example, a natural substance, a polymer or a metal material. It may, for example, comprise the same material as the molded components 21, 22 of the device.

In FIG. 4 there is highlighted by the circle a cut-out of the structural element 25, in which perforations 26 can be seen in the material. The perforations are constructed to be round. Alternatively, they may also have a different shape. The perforations 26 are used to efficiently draw air from the device 2. The perforations 26 are optional

The structural element 25 extends, as shown in FIGS. 1 and 3 over the entire face of the hollow space 24. The structural element 25 may also be constructed differently from that shown, for example, in undulating form. A plurality of structural elements 25 may also be provided. In this instance, individual elements 25 are then arranged at different locations of the hollow space, ideally distributed in a uniform manner.

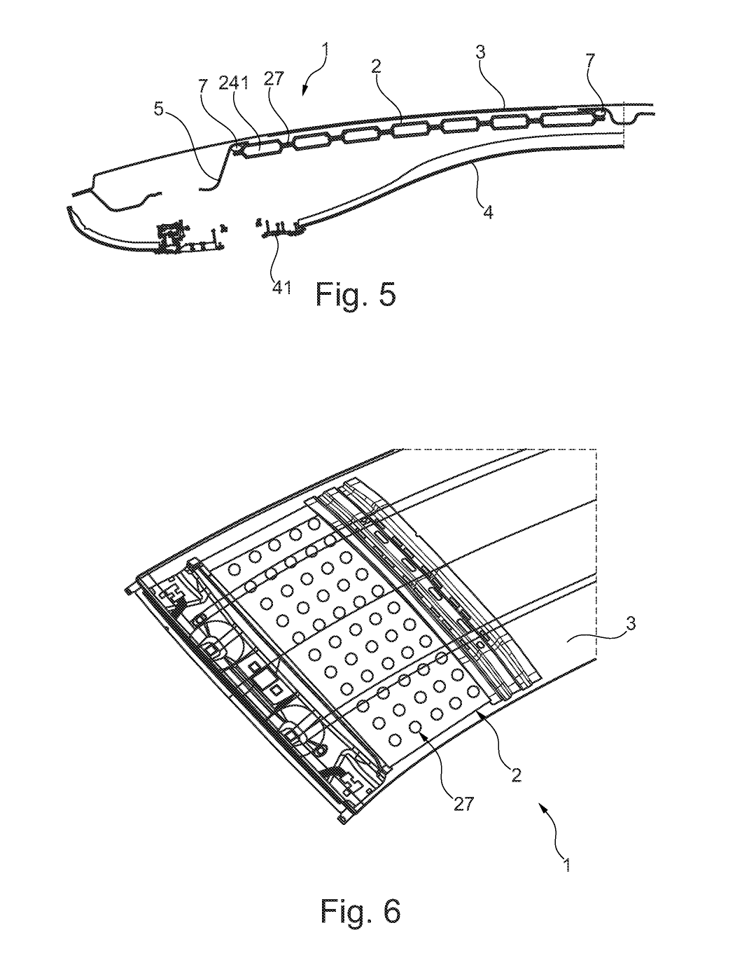

In another embodiment, the device 2 may be constructed in such a manner that the first molded component 21 and the second molded component 22 in addition to the edges are connected to each other at least at one additional location. That is to say, the molded components 21, 22 have connections 27 to each other through the hollow space 24. In this instance, the connections may be constructed in such a manner that they extend over the entire width of the device 2 (FIG. 5) so that in principle not one hollow space 24, but instead a large number of sub-hollow spaces 241 are provided. The connections 27 may also be constructed in such a manner that they are located locally at different locations (FIG. 6), wherein the connections 27 in order to ensure the stability of the device 2 are distributed in a uniform manner in the hollow space 24. The said embodiments may also be combined with each other so that in the sub-hollow spaces 241 connections 27 which are arranged locally may also be provided.

What is claimed:

1. A thermally insulating device for a vehicle, comprising:
at least a first molded component that is constructed at least partially in a planar manner and is shaped to surround a hollow space in an air-tight manner, said first molded component having at least a first outer side and at least a first inner side, wherein the first inner side faces the hollow space,
wherein the hollow space is evacuated.

2. The device as claimed in claim 1, further including at least a second molded component constructed at least partially in a planar manner and having a second outer side and a second inner side, wherein the first molded component and the second molded component are arranged with the first inner side and the second inner side facing each other and surrounding the hollow space, wherein the said first molded component and the second molded component are connected to each other in an air-tight manner at least at edges thereof.

3. The device as claimed in claim 2, further including at least one structural element in the hollow space that supports structural integrity of the device.

4. The device as claimed in claim 3, wherein the at least one structural element has at least one protuberance, in which at least two flanks of the structural element taper toward each other.

5. The device as claimed in claim 4, wherein the structural element has a planar construction which is folded in corrugations.

6. The device as claimed in claim 5, wherein the structural element has at least one perforation.

7. The device as claimed in claim 6, wherein the first molded component and the second molded component that surround the hollow space are connected within the edges at least at one additional location of the hollow space.

8. The device as claimed in claim 7, wherein adjacent the edge of the at least first outer side there is arranged at least one insulating support that is constructed to provide a thermally insulating connection between the device and structures of the vehicle, in which the device is arranged.

9. The device as claimed in claim 8, wherein the first molded component and the second molded component comprise a polymer material.

10. The device as claimed in claim 1, further including at least one structural element in the hollow space that supports structural integrity of the device.

11. The device as claimed in claim 10, wherein the structural element has at least one protuberance, in which at least two flanks of the structural element taper toward each other.

12. The device as claimed in claim 10, wherein the structural element has a planar construction which is folded in corrugations.

13. The device as claimed in claim 12, wherein the structural element has at least one perforation.

14. The device as claimed in claim 10, wherein the structural element has at least one perforation.

15. The device as claimed in claim 11, wherein the structural element has at least one perforation.

16. The device as claimed in claim 2, wherein the first molded component and the second molded component that surround the hollow space are connected within the edges at least at one additional location of the hollow space.

17. The device as claimed in claim 16, wherein adjacent the edge of the at least first outer side there is arranged at least one insulating support that is constructed to provide a thermally insulating connection between the device and structures of the vehicle, in which the device is arranged.

18. The device as claimed in claim 1, wherein adjacent the edge of the at least first outer side there is arranged at least one insulating support that is constructed to provide a thermally insulating connection between the device and structures of the vehicle, in which the device is arranged.

19. The device as claimed in claim 2, wherein the first molded component and the second molded component comprise a polymer material.

20. The vehicle having the device as claimed in claim 1.
